(19) United States
(12) Patent Application Publication
(10) Pub. No.: US 2022/0322154 A1
(43) Pub. Date: Oct. 6, 2022

(54) Network Slice Quality of Experience Measurements

(71) Applicant: ZTE Corporation, Shenzhen (CN)

(72) Inventors: Zhuang LIU, Shenzhen (CN); Dapeng LI, Shenzhen (CN); Yin GAO, Shenzhen (CN)

(73) Assignee: ZTE Corporation, Shenzhen, Guangdong (CN)

(21) Appl. No.: 17/849,383

(22) Filed: Jun. 24, 2022

Related U.S. Application Data
(63) Continuation of application No. PCT/CN2020/105372, filed on Jul. 29, 2020.

(51) Int. Cl. H04W 28/24; H04W 28/06; H04W 24/10; H04W 48/18

(52) U.S. Cl. CPC H04W 28/24; H04W 28/06; H04W 24/10; H04W 48/18

(57) ABSTRACT

This disclosure describes methods and systems for configuring, performing, reporting, and analyzing user quality of experience measurements of virtual network slices in a wireless communication network platform. The measurements are performed by the user devices and thus more accurately reflect a true user experience with respect to network latency, throughput, and/or data loss. The measurements are triggered via a messaging procedure involving the core network and the access network of the wireless communication network platform. The measurement results are reported by the user device to the network side for optimizing network resource allocation and configuration of the virtual network slices to improve user experience.

### TECHNICAL FIELD

This disclosure is directed to measuring and monitoring wireless network performance and user quality of experience (QoE).

### BACKGROUND

Virtual networks such as wireless virtual network slices may be implemented over a common physical network infrastructure. User equipment may transparently subscribe to wireless services provided by these virtual wireless network. Physical or logical communication resources of the underlying network infrastructure may be allocated and adjusted among various network slices according to their communication service quality requirements.

### SUMMARY

This disclosure describes methods and systems for configuring, measuring, reporting, and optimizing user quality of experience of virtual networks such as network slices.

In one example implementation, a method performed by a network node of a communication network platform for measuring performance of network slices implemented in the communication network platform is disclosed. The method include receiving a configuration message associated with a measurement task of one or more network slices specifying a set of measurement configuration information; identifying a user device to perform a network slice performance measurement according to the configuration message; constructing a measurement request based on the configuration message; and transmitting the measurement request to the user device to trigger the network slice performance measurement by the user device.

In the implementation above, the communication network platform may include a cellular wireless network and the network node comprises a wireless base station, and the performance of network slices comprises user quality of experience (QoE).

In any one of the implementations above, the QoE comprises at least one of network latency, throughput, or data losses as experienced by the user device.

In any one of the implementations above, the set of measurement configuration information comprises at least one of: an area scope information for identifying network coverage areas in which network slice performance measurements are to be performed; a network address information of a QoE collection entity (QCE) configured to collect and analyze network slice performance measurements; a network slice measurement enablement indicator to indicate whether network slice measurement function is enabled or not; a list of network slice identities for specifying the one or more network slices; a measurement traffic granularity for specifying one or more network levels at which the performance of the one or more network slices is measured; or a task identity of the measurement task associated with the set of measurement configuration information.

In any one of the implementations above, the one or more network levels comprises at least one of a dedicated radio bearer (DRB) level, a protocol data unit (PDU) session level, or a quality of service (QoS) flow level.

In any one of the implementations above, the configuration message is transmitted from an operation and administration management (OAM) function of the communication network platform to the network node.

In any one of the implementations above, the configuration message is transmitted from the OAM as a minimization of drive test (MDT) activation message.

In any one of the implementations above, identifying the user device includes selecting by the network node the user device among a plurality of network devices within a coverage area of the network node according to the set of measurement configuration information.

In any one of the implementations above, the configuration message is transmitted from a core network or another base station of the communication network platform to the network node and specifies the user device to perform the network slice performance measurement.

In any one of the implementations above, the measurement request is included in a radio resource control (RRC) message transmitted from the network node to the user device.

In any one of the implementations above, the measurement request included in the RRC message includes at least one of: an indicator to indicate whether network slice measurement function is enabled or not; a measurement traffic granularity for specifying one or more network levels at which the network slice performance measurement is performed by the user device; a task identity of the measurement task associated with the set of measurement configuration information; or a list of network slice identities for specifying the one or more network slices.

In any one of the implementations above, the measurement request cause the user device to: perform the network slice performance measurement for a set of network slices when network slice identities associated with the set of network slices and a network slice measurement enablement indicator are specified in the measurement request; and perform the network slice performance measurement according to a network granularity specified in the measurement request when the network slice measurement enablement indicator is specified in the measurement request but no network slice identities are included in the measurement request.

Any one of the implementations above, further includes receiving a network slice measurement report from the user device.

Any one of the implementations above, further includes forwarding the network slice measurement report received from the user device to a core network or a QCE of the communication network platform when one or more network slice identifiers are present in the network slice measurement report.

Any one of the implementations above, further includes: when the network slice measurement report does not include any network slice identities, forwarding the network slice measurement report received from the user device without network slice identities to a core network or a QCE of the communication network platform, or identifying a set of network slice identifier associated with the network slice measurement report by one or more traffic identifiers included in the network slice measurement report followed by forwarding the network slice measurement report and the set of network slice identifiers to a core network or a QCE of the communication network platform. The traffic identifiers include at least one of: one or more DRB identifiers; one or more PDU session identifiers; or one or more QOS flow identifiers.

In any one of the implementations above, the network node forward the network slice measurement report to a core network or a QCE of the communication network platform to cause the core network or the QCE to perform optimization resource allocations for the one or more network slices according to the network slice measurement report and performance requirement specified in service-level agreements associated with the one or more network slices.

Various network nodes are further disclosed. Each of these network nodes includes a processor and a memory, wherein the processor is configured to read computer code from the memory to implement any one of the methods described above.

Computer-readable media are further disclosed. Such a computer-readable medium includes instructions which, when executed by a computer, cause the computer to carry out any one of the methods described above.

The above embodiments and other aspects and alternatives of their implementations are described in greater detail in the drawings, the descriptions, and the claims below.

### BRIEF DESCRIPTION OF THE DRAWINGS

FIG. 1 illustrates an exemplary system diagram of a wireless communication network.

FIG. 2 illustrates an exemplary logic flow for configuring, measuring, reporting, collecting, and analyzing user quality of experience information of network slices.

FIG. 3 illustrates another exemplary logic flow for configuring, measuring, reporting, collecting, and analyzing user quality of experience information of network slices.

FIG. 4 illustrates yet another exemplary logic flow for configuring, measuring, reporting, collecting, and analyzing slice quality of experience information of network slices.

### DETAILED DESCRIPTION

The technology and examples of implementations and/or embodiments in this disclosure can be used to improve performance of virtual networks in communication systems. The term “exemplary” is used to mean “an example of” and unless otherwise stated, does not imply an ideal or preferred example, implementation, or embodiment. The implementations may be embodied in a variety of different forms and, therefore, the scope of this disclosure or claimed subject matter is intended to be construed as not being limited to any of the embodiments set forth below. The various implementations may be embodied as methods, devices, components, or systems. Accordingly, embodiments of this disclosure may, for example, take the form of hardware, software, firmware or any combination thereof.

This disclosure relates to methods and systems for configuring, measuring, reporting, collecting, and analyzing user quality of experience (QoE) information from user devices in virtual networks, and using such information to optimize the performance of the virtual networks. By way of introduction to network virtualization, one or more virtual networks, alternatively referred as logic networks, may be independently implemented over a common physical network infrastructure of a communication network system. In a wireless network system, virtual networks may be implemented as network slices. These network slices share the same underlying physical network infrastructure including wireless access networks and core networks, but provide independent network services to subscribers. While the disclosure below is provided in the context of wireless communication systems, such as the fourth generation (4G) and fifth generation (5G) cellular networks, the underlying principles of this disclosure are applicable to other wireless infrastructures, as well as other wireline networks supporting virtual networks in the form including but not limited to virtual network slices.

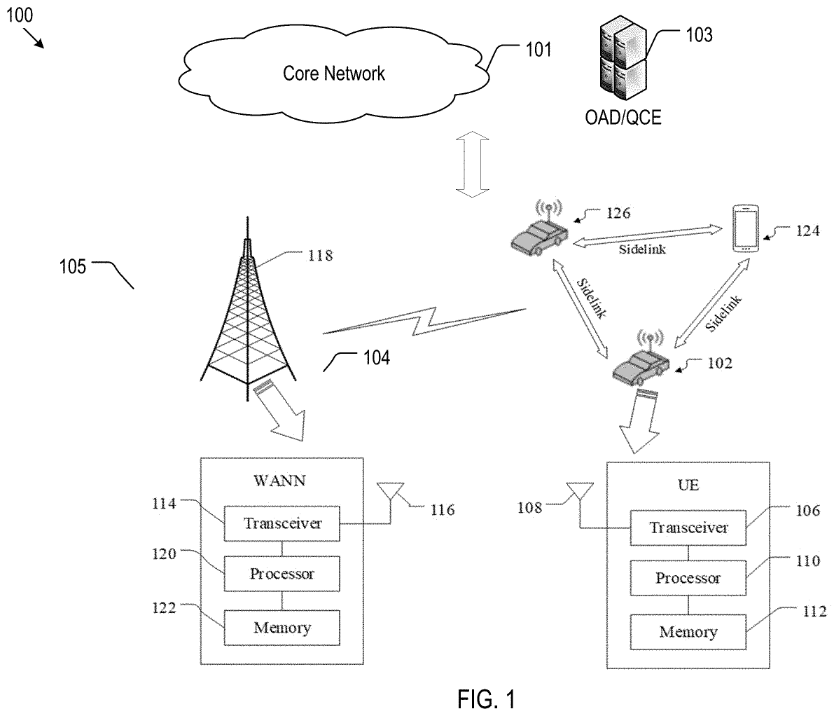

FIG. 1 illustrates an example wireless communication network system 100 including a wireless radio access network (RAN) 105 backhauled to a core network 101. The RAN 105, for example, may include various radio access network nodes (RANNs) 104 and user equipments (UEs) 102, 124, and 126 that access the RANNs 104. Each of the UEs 102, 124, and 126 may include but is not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly. The UEs may indirectly communicate with each other via the RANN 104 or via both the RANN 104 and the core network 101, or directly via sidelinks between the UEs. As shown in FIG. 1, UE 102, for example, may include a transceiver circuitry 106 coupled to an antenna 108 to effectuate wireless communication with the RANN 104 or with another UE such as UE 124 or 126. The transceiver circuitry 106 may also be coupled to a processor 110, which may also be coupled to a memory 112 or other storage devices. The memory 112 may store therein computer instructions or code which, when read and executed by the processor 110, cause the processor 110 to implement all or a portion of each of the various methods described herein.

Similarly, the RANN 104 may include a base station or other wireless network access points capable of communicating wirelessly with one or more UEs. For example, the RANN 104 may be implemented in the form of a 4G LTE base station, a 5G NR base station, a 5G central-unit base station, or a 5G distributed-unit base station (the various 5G base stations may be alternatively referred to as next generation nodeB, or gNB). Each type of these RANNs 104 may be configured to perform a corresponding set of wireless network functions. The RANN 104 may include a transceiver circuitry 114 coupled to an antenna 116, which may include an antenna tower 118 in various forms, to effectuate wireless communications with the UEs 102, 124, and 126. The transceiver circuitry 114 may be coupled to one or more processors 120, which may further be coupled to a memory 122 or other storage devices. The memory 122 may store therein instructions or code that, when read and executed by the processor 120, cause the processor 120 to implement various network functions. These network functions, for example, may include those related to the configuration, measurement, reporting, collection, and analysis of user QoE information of virtual networks running in the wireless communication network platform 100.

For simplicity and clarity, only one RANN 104 and three UEs 102, 124, and 126 are shown in the radio access network 105. It will be appreciated that one or more RANNs 104 may exist in the wireless communication network system 100, and each RANN may serve one or more UEs. While the UEs 102, 124, and 126 of FIG. 1 are shown as being served within one serving cell, they may alternatively be served by different cells and/or by no cell (e.g., when communicating with one another via sidelinks).

Network applications in communication systems such as the example shown in FIG. 1 may be configured to provide one or more mobile services and applications requiring various levels of mobile coverage, throughput, latency, and the like. For example, in the context of 5G mobile networks, a diverse set of mobile services and use cases may be provided by a single physical network infrastructure. In some implementations, the various services and use cases may be virtualized, corresponding to a set of virtual communication networks overlaid on top of the single physical network infrastructure 100 shown in FIG. 1. Such virtual networks may be alternatively referred to as logic networks to distinguish from the underlying physical network infrastructure. Vitalization of the communication network helps avoid a need to deploy separate physical network infrastructures for distinct network services and greatly increases utilization and efficiency of network infrastructures. Virtual networks deployed over the same underlying network infrastructure of, e.g., 100 of FIG. 1, may be implemented as network slices. Each of the various network slices may be configured to support end-to-end communication sessions independently using the radio access network 105 and the core network 101 shown in FIG. 1. Network resources may be allocated and adjusted among the various network slices according to communication characteristics and requirements of the network services provided by these virtualized network slices.

Network slices implemented in the wireless communication network system 100 of FIG. 1 allow for differentiated network configurations and treatment of services depending on customer requirements. The RAN 105 may be configured to provide different network slices to serve one or more UEs. Each network slice may be uniquely identified by a network slice identifier (ID), contained in a Single Slice Selection Assistance Information (S-NSSAI). Each UE may subscribe to one or more virtual network services in the form of network slices corresponding to a list of S-NSSAIs, collectively referred to as NSSAI. Each network slice, when providing service to a UE, may support one or more communication sessions, referred to as Protocol Data Units (PDUs). The wireless communication system 100 of FIG. 1 may realize the various network slices by resource scheduling and by providing corresponding layer 1 or layer 2 configurations.

In some implementations, the UE 102, in requesting a network communication session during a network access procedure, may provide the list of NSSAI subscription information to the RANN 104 for requesting a network slice among the network slices corresponding to the NSSAI for supporting the network communication session. Such an access request may be communicated to the core network 101 via the RANN 104. The core network 101 may then perform validation by verifying that the UE 102 has the rights to access a network slice. The RANN 104 then sends an initial context setup request message including the NSSAI list provided by UE 102 to the core network 101. The core network 101 may then select a particular network slice corresponding to an S-NSSAI among the list of network slices corresponding to the NSSAI information from the UE to support the requested network communication session. The core network 101 may then inform the RANN 104 of the selected S-NSSAI for signaling.

During the access procedure above, the RANN 104 is aware of the signaled S-NSSAI by the core network 101 and may be responsible for allocating the corresponding wireless communication resources for the signaled network slice to the UE 102. The UE, however, may not need to be informed of and thus would not be aware of the identifier for the particular S-NSSAI selected by the core network 101 from the list of NSSAIs for the requested communication session.

The communication system 100 of FIG. 1 may be further responsible for providing and optimizing the network slice configuration and resource allocation to meet network slice performance requirement specified in Service-Level Agreements (SLAs) between the provider of the physical network infrastructure and the various virtual network service providers. Such resource optimization may be based on various network performance measurements and metrics of particular network slices.

While some network performance metrics corresponding to the network slices may be measured and analyzed from the network side (e.g., the RANN 104 and the core network 101), other performance metrics, such as user Quality of Experience (QoE), may need to be measured and reported from the UE side. However, because UE may not be aware of the identity of the particular signaled single network slice for the requested communication session, as described above, it may not be able to collect and report QoE measurements for a given network slice.

In the examples described below, several measurement and reporting mechanisms may be implemented for collecting QoE information for various network slices for the purpose of network optimization. In some implementations, as shown in FIG. 1, the communication system 100 may include an additional QoE Collection Entity (QCE) 103 to manage user experience data collection and/or analysis for the optimization of the performance of the network slices. The QCE, for example, may be implemented as centralized for distributed servers in communication with the RAN 105 and the core network 101. Alternatively, the QCE may be implemented as part of the core network 101 or part of the RAN 105. In some particular example implementations, the QCE may be implemented within the Operation, Administration and Maintenance (OAM) function of the communication network 100.

In the various implementations below, the various components of the communication network 100 including the QCE 103, the core network 101, the RANN 104, and the UE 102 interact with one another to collaboratively collect the QoE information for particular network slices with corresponding S-NSSAIs for optimization of the network slice performance. While the UE 102 is the entity responsible for preforming and reporting the QoE measurements, it may or may not be aware of the S-NSSAI. The QoE, for example, may be defined and quantified at application level and as such, the QoE measurements may take place at the UE's application layers. The QoE measurements may include but are not limited to measurements of network throughputs, data loss, and communication latency at the UE 102.

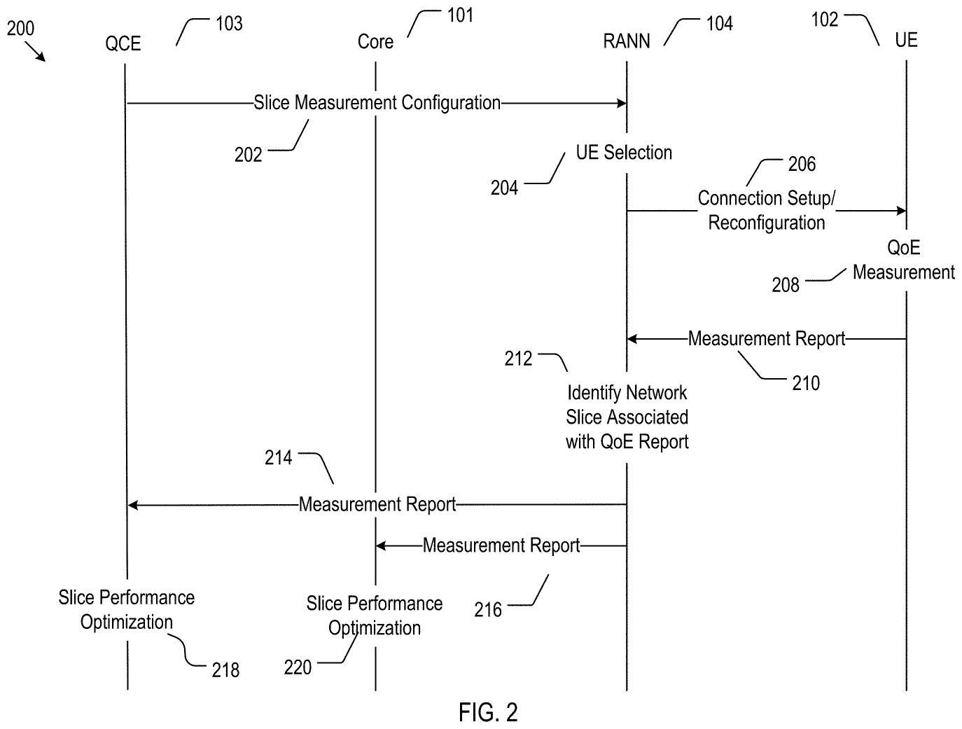

FIG. 2 shows an exemplary logic flow and procedure 200 for configuring, measuring, reporting, collecting, and analyzing user QoE information of network slices. The procedure may be initiated by the QCE 103 as a need for network slice performance optimization arises. Alternatively, the QCE 103 may initiate the procedure 200 periodically or on any given time schedule. The procedure 200 may be implemented in the following steps.

In Step 1, as shown in 202 of FIG. 2, the QCE 103 initiates the network slice measurement procedure by transmitting network slice measurement configuration information to one or more RANNs 104. The RANNs 104 receive the network slice measurement configuration information. Such network slice measurement configuration information may be transmitted in any form or communication protocol established between the QCE 103 and the RANNs 104. In some implementations, for example, the network slice measurement configuration information may be transmitted as messages in a Minimization of Drive Test (MDT) messaging framework. In particular, the MDT messaging may be used beyond configuring UE testing and measurements of wireless network conditions at various locations through various drive routes of UEs. The network slice measurement configuration information may be carried as one or more MDT activation messages, or as part of one or more MDT activation messages. The network slice measurement configuration messages may be transmitted by the QCE 103 to particular RANNs 104 covering network areas needing QoE measurements. While the MDT messages may be transmitted to multiple RANNs, the other steps of the procedure 200 below focus on a single RANN 104, and these steps are applicable to any other RANN covering the areas needing network slice QoE measurements.

The network slice measurement configuration information carried in, e.g., one or more MDT activation messages, may be used to configure network slice measurement policy for the UEs accessing the RANNs 104. The network slice measurement configuration information may include at least one of: Area Scope Information (ASI), Server Address Information (SAI); slice monitor indication; an S-NSSAI list corresponding to network slices to be measured; measurement traffic granularity; QoE Measurement Collection (QMC) Identifiers (IDs); and QoE measurement configuration information.

The area scope information, or ASI, for example, may be used to define the service areas in which user network slice QoE needs to be measured, as determined by the QCE 103. Such area scope information may be provided in terms of serving cells, tracking areas, routing areas, or location areas in which the QoE measurements shall take place.

The server address information, or SAI, may contain information that indicates the address of the QCE 103. For example, the SAI may include the QCE's IP addresses to which the slice measurement reports shall be transferred for analysis and for network slice optimization.

The slice monitor indication may be used to indicate whether the network slice measurement function is enabled or not. The measurement traffic granularity included in the network slice measurement configuration information may be used to indicate the network level at which the network slice measurements shall be performed. Such granularity levels may include but are not limited to a Dedicated Radio Barrier (DRB) level, a PDU session level, or a network Quality of Service (QoS) flow level. The QMC identifiers are used to uniquely identify the particular network slice QoE measurement tasks. The QoE measurement configuration information above may be used to indicate and prescribe the types of QoE measurement needed from the UE 102 (such as network throughputs, data loss, and communication latency of a network slice at the UE 102).

In Step 2, as shown by 204 of FIG. 2, the RANN 104 selects some UEs 102 to perform network slice measurements according to the network slice measurement configuration information received from the QCE 103 in Step 1. For a specific example, the network slice measurement configuration information may include area scope in the form of a particular serving cell of a particular RANN 104. As such, the particular RANN 104, upon receiving the network slice measurement configuration information, may select UEs currently accessing the wireless network within the particular serving cell to perform and report network slice QoE measurements. For another example, the RANN 104 may select UEs 102 according to the network quality condition as measured by the RANN 104 or the core network 101 from the network side.

In Step 3, as shown by 206 of FIG. 2, the RANN 104, after selecting UEs 102 for network slice QoE measurements, may transmit request messages to the selected UEs 102 to request the UEs to perform network slice QoE measurements. Such request messages, for example, may be transmitted as one or more Radio Resource Control (RRC) setup request messages or RRC reconfiguration messages. The request messages may contain information including but not limited to at least one of: the network slice monitor indication (as included in the network slice measurement configuration information transmitted from the QCE 103 to the RANN 104 for indicating whether network slice measurement function is enabled or not at the UEs 102); the measurement traffic granularity (as included in the network slice measurement configuration information transmitted from the QCE 103 to the RANN 104 for indicating network granularity level for the QoE measurement, including, for example the DRB level, PDU session level, or QoS flow level); the QMC identifier described above for identifying the QoE measurement task associated with the network slice QoE measurement configuration information transmitted from the QCE 103; and the QoE measurement configuration information. While multiple UEs 102 may be selected by the RANN 104 to perform and report network slice QoE measurements, the further steps below focus on one UE 102 and these steps are applicable to any other UE selected by the RANN 104 to perform network slice QoE measurements.

In Step 4 as shown by 208 of FIG. 2, a UE 102 selected by the RANN 104 performs the QoE measurements upon receiving the network slice measurement request message from the RANN 104. The QoE measurements, for example, may be perform by the application layers in the UE 102 in accordance with the received request messages from the RANN 104 in the form of, for example, RRC setup request messages or the RRC reconfiguration request messages.

In Step 5, as shown by 210 of FIG. 2, the UE 102 transmits a measurement report to the RANN 104. The measurement report, for example, may include at least one of the QMC ID described above for identifying the QoE measurement task associated with the QoE measurement configuration information transmitted from the QCE 103, results of QoE measurements by the UE 102, and the associated DRB identifier or PDU session identifier or QOS flow ID depending on the network level at which the network slice QoE measurements are performed. Alternatively, the UE 102 may use any network traffic identifier that is unique in the namespace between the RANN 104 and the UE 102 and include such an identifier in the UE measurement report for identifying the measurement task to the RANN 104.

In Step 6, as shown by 212 of FIG. 2, the RANN 104 determines the identity of the network slice associated with the QoE results reported by the UE 102 according to the traffic identifier (e.g., DRB ID, QoS flow ID, or PDU session ID) or any other optional network traffic identifier included in the report.

In Step 7, as shown by 214 and 216 of FIG. 2, the RANN 104 forwards the measurement report received from the UE 102 to the core network 101 (as shown by 214 in FIG. 2) or QCE 103 (as shown by 216 of FIG. 2). Alternatively, the RANN 104 may be configured to first determine the slice identifier (S-NSSAI) associated with the received QoE results/report using a correspondence between the traffic identifier (DRB ID/QOS flow ID/PDU session ID, or any other optional traffic identifier) associated with the measurement report and the various S-NSSAIs, and forward the measurement report and the corresponding S-NSSAI to the core network 101 or the QCE 103.

In Step 8, as shown by 218 and 220 of FIG. 2, the core network 101 or the QCE 103, upon receiving the measurement report (or optionally, the measurement report and the associated S-NSSAI) from the RANN 104, may use the received QoE measurement information for the network slices to determine the user experience, and to optimize the network slice resource allocation and configuration to ensure that the network slice performance meet the corresponding SLA. The optimization of various network slices may be performed by collectively considering one or more measurement reports by various UEs from various RANNs.

In some specific implementations according the procedure 200 of FIG. 2, when a list of one or more S-NSSAIs and a network slice measurement enablement indicator is included in the network slice measurement configuration information as transmitted from the RANN 104 to the UE 102 in Step 3, the UE 102 may then perform in Step 4 QoE measurements of the network slices associated with the list of one or more S-NSSAIs and transmit the measurement report to the RANN 104 in Step 5. The measurement report transmitted from the UE 102 to the RANN 104 in Step 5 may include QoE measurement results and corresponding S-NSSAIs of the measured network slices. When no S-NSSAI is specified in the network slice measurement configuration information but the network slice measurement enablement indicator is nevertheless enabled, the UE 102 may then perform in Step 4 the QoE measurements of network slices according traffic granularity information specified in the network slice measurement configuration information. Such granularity information, as described above, may be specified at various network levels such as the DRB level, the PDU session level, and/or the QoS flow level. The measurement report transmitted from the UE 102 to the RANN 104 in step 5 may include QoE measurement results and corresponding network granularity or network level information.

In some further specific implementations according to the procedure 200 of FIG. 2, when the measurement report transmitted from the UE 102 to the RANN 104 in Step 5 contains one or more S-NSSAIs, the RANN 104 may then forward such measurement report to the core network 101 or the QCE 103 in Step 7. When the measurement report transmitted from the UE 102 to the RANN 104 in Step 5 does not contains any S-NSSAI, the RANN 104 may then determine the S-NSSAIs corresponding to the measurement report based on the traffic granularity information included in the measurement report in Step 6, and then forward the measurement report and the S-NSSAIs as determined by the RANN 104 to the core network 101 or the QCE 103 in Step 7.

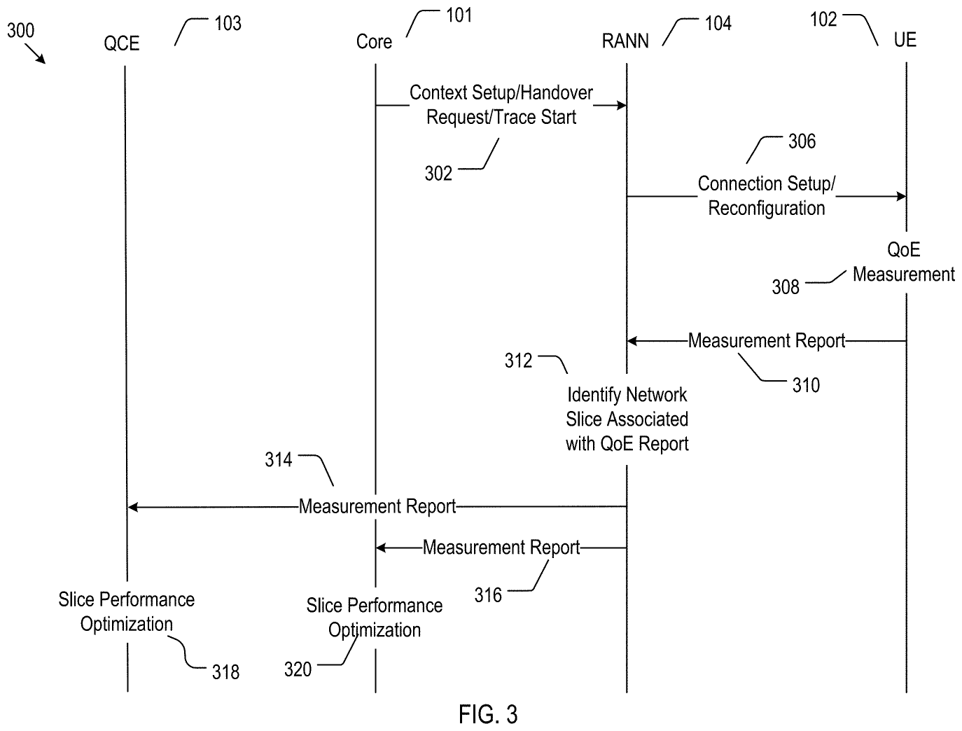

FIG. 3 shows another exemplary logic flow and procedure 300 for configuring, measuring, reporting, collecting, and analyzing user QoE information of network slices. In comparison with the implementation 200 of FIG. 2, the procedure 300 in FIG. 3 may be initiated by the core network 101 rather than the QCE 103. In particular, the core network 101 may initiate the procedure 300 as the need for network slice performance optimization arises. Alternatively, the core network 101 may initiate the procedure 300 periodically or on any given time schedule. The procedure 300 may be implemented in the following steps.

In Step 1, as shown in 302 of FIG. 3, the core network 101 initiates the network slice measurement procedure by transmitting network slice measurement configuration information to one or more RANNs 104. The RANNs 104 receive the network slice measurement configuration information. Such network slice measurement configuration information may be transmitted in any form or communication protocol established between the core network 101 and the RANNs 104. For example, the core network may transmit the network slice measurement configuration information to the RANNs 104 via initial context setup request messages, handover request messages, or trace start messages associated with a specific UE 102 for requesting the specific UE 102 to perform and report network slice QoE measurements. Alternatively, the RANN 104 may receive handover request message or trace start message associated with the specific UE 102 from another RANN, and such messages may include network slice measurement configuration information for requesting the particular UE 102 to perform and report network slice QoE measurements. The network slice measurement configuration information contains network slice measuring policies for the particular UE 102 accessing the RANN 104.

The network slice measurement configuration information carried in, e.g., one or more initial context setup messages, handover messages, or trace start messages from the core network 101 (or another RANN) as described in Step 1 may include at least one of: ASI, SAI, slice monitor indication, a S-NSSAI list, measurement traffic granularity, QMC ID, and the QoE measurement configuration, as described above in more detail with respect to Step 1 of FIG. 2.

In Step 2, as shown by 306 of FIG. 2, the RANN 104, upon receiving the network slice measurement configuration information from the core network 101 or another RANN, transmits such network slice measurement configuration information to the corresponding UE 102 as one or more network slice measurement request messages in the form of, for example, RRC setup request messages or RRC reconfiguration request messages, to request the UE 102 to perform network slice QoE measurements according to the transmitted network slice measurement configuration information. The one or more network slice measurement request messages transmitted by the RANN 104 to the UE 102 may contain information including but not limited to at least one of: the slice monitor indication indicating whether slice measurement function is enabled or not at the UE 102; the measured traffic granularity, the QMC ID; and the QoE measurement configuration, as described in more detail above.

Step 3-7 corresponding to 308, 310, 312, 314/316, and 318/320 of FIG. 3, are similar to steps 4-8 of FIG. 2. More details for these steps are described above with respect to FIG. 2.

In some specific implementations according the procedure 300 of FIG. 3, when a list of one or more S-NSSAIs and a network slice measurement enablement indicator is included in the network slice measurement configuration information as transmitted from the RANN 104 to the UE 102 in Step 2, the UE 102 may then perform in Step 3 QoE measurements of the network slices associated with the list of one or more S-NSSAIs and transmit the measurement report to the RANN 104 in Step 4. The measurement report transmitted from the UE 102 to the RANN 104 in Step 4 may include QoE measurement results and corresponding S-NSSAIs of the measured network slices. When no S-NSSAI is specified in the network slice measurement configuration information but the network slice measurement enablement indicator is nevertheless enabled, the UE 102 may then perform in Step 3 the QoE measurements of network slices according traffic granularity information specified in the network slice measurement configuration information. Such granularity information, as described above, may be specified at various network levels such as the DRB level, the PDU session level, and/or the QoS flow level. The measurement report transmitted from the UE 102 to the RANN 104 in step 4 may include QoE measurement results and corresponding network granularity or network level information.

In some further specific implementations according to the procedure 300 of FIG. 3, when the measurement report transmitted from the UE 102 to the RANN 104 in Step 4 contains one or more S-NSSAIs, the RANN 104 may then forward such measurement report to the core network 101 or the QCE 103 in Step 6. When the measurement report transmitted from the UE 102 to the RANN 104 in Step 4 does not contains any S-NSSAI, the RANN 104 may then determine the S-NSSAIs corresponding to the measurement report based on the traffic granularity information included in the measurement report in Step 5, and then forward the measurement report and the S-NSSAIs as determined by the RANN 104 to the core network 101 or the QCE 103 in Step 6.

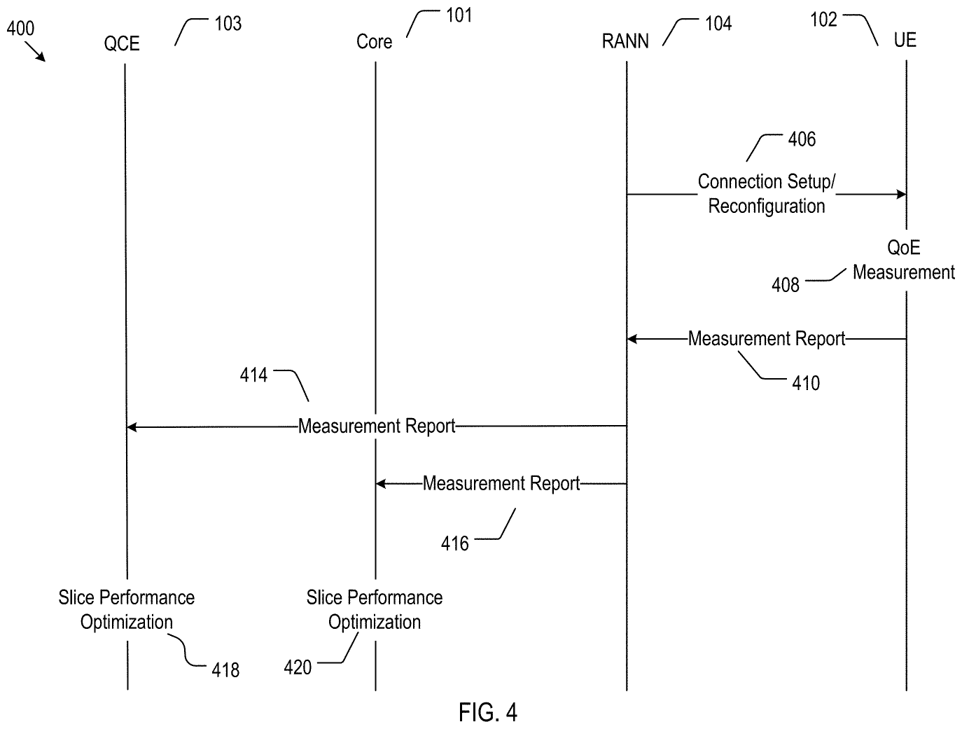

FIG. 4 shows yet another exemplary logic flow and procedure 400 for configuring, measuring, reporting, collecting, and analyzing network slice user QoE information of network slices. In comparison with the implementations 200 and 300 of FIGS. 2 and 3, the procedure 400 in FIG. 4 is implemented in the context that the UE requested to perform the network slice QoE measurements is informed of the S-NSSAI of the network slice to be measured.

In Step 1, as shown by 406 of FIG. 4, the RANN 104, may directly transmit one or more network slice measurement request messages to a specific UE 102 to request the UE 102 to perform and report QoE measurements of specific network slices. Such request messages may be transmitted during a connection establishment procedure or a UE resource modification procedure in form of, for example, RRC messages. The network slice measurement request messages may contain information including but not limited to at least one: slice monitor indication for indicating whether slice measurement function is enabled or not at the UE 102; QMC ID for uniquely identifying the requested QoE measurement task; an S-NSSAI list indicate one or more S-NSSAIs of network slices configured with PDU sessions for the UE 102 for which the network slice QoE measurements are requested; and QoE measurement configuration as described above with respect to FIGS. 1 and 2.

In Step 2, as shown by 408 of FIG. 4, the UE 102 performs QoE measurement by its application layers for the network slices indicated in the S-NSSAI list contained in the network slice measurement request messages received by the UE 102 from the RANN 104. More details are provided in the description above with respect to 208 and 308 of FIGS. 2 and 3, respectively.

Steps 3, 4, and 5, as shown by 410, 414/416, 418/420, are similar to 310, 314/316, 318/320 of FIG. 3, or 210, 214/216, and 218/220 of FIG. 2. Because the network slice identification information is known by the UE 102 and the RANN 104, the RANN 104 would not need to perform a specific step to identify the network slice associated with the QoE measurement report received from the UE 102, unlike the procedures 200 and 300 of FIGS. 2 and 3 (e.g., the steps corresponding to 212 and 312 of FIGS. 2 and 3 would not be necessary in the procedure 400 of FIG. 4).

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a network node of a communication network platform for measuring performance of network slices implemented in the communication network platform, comprising:
receiving a configuration message associated with a measurement task of one or more network slices specifying a set of measurement configuration information;
identifying a user device to perform a network slice performance measurement according to the configuration message;
constructing a measurement request based on the configuration message; and
transmitting the measurement request to the user device to trigger the network slice performance measurement by the user device.

2. The method of claim 1, wherein:
the communication network platform comprises a cellular wireless network and the network node comprises a wireless base station; and
the performance of network slices comprises user quality of experience (QoE).

3. The method of claim 2, wherein the QoE comprises at least one of network latency, throughput, or data losses as experienced by the user device.

4. The method of claim 2, wherein the set of measurement configuration information comprises at least one of:
an area scope information for identifying network coverage areas in which network slice performance measurements are to be performed;
a network address information of a QoE collection entity (QCE) configured to collect and analyze network slice performance measurements;
a network slice measurement enablement indicator to indicate whether network slice measurement function is enabled or not;
a list of network slice identities for specifying the one or more network slices;
a measurement traffic granularity for specifying one or more network levels at which the performance of the one or more network slices is measured; or
a task identity of the measurement task associated with the set of measurement configuration information.

5. The method of claim 4, wherein the one or more network levels comprises at least one of a dedicated radio bearer (DRB) level, a protocol data unit (PDU) session level, or a quality of service (QoS) flow level.

6. The method of claim 2, wherein the configuration message is transmitted from an operation and administration management (OAM) function of the communication network platform to the network node.

7. The method of claim 6, wherein the configuration message is transmitted from the OAM as a minimization of drive test (MDT) activation message.

8. The method of claim 6, wherein identifying the user device comprises selecting by the network node the user device among a plurality of network devices within a coverage area of the network node according to the set of measurement configuration information.

9. The method of claim 2, wherein the configuration message is transmitted from a core network or another base station of the communication network platform to the network node and specifies the user device to perform the network slice performance measurement.

10. The method of claim 2, wherein the measurement request is included in a radio resource control (RRC) message transmitted from the network node to the user device.

11. The method of claim 10, wherein the measurement request included in the RRC message comprises at least one of:
an indicator to indicate whether network slice measurement function is enabled or not;
a measurement traffic granularity for specifying one or more network levels at which the network slice performance measurement is performed by the user device;
a task identity of the measurement task associated with the set of measurement configuration information; or
a list of network slice identities for specifying the one or more network slices.

12. The method of claim 10, wherein the measurement request cause the user device to:
perform the network slice performance measurement for a set of network slices when network slice identities associated with the set of network slices and a network slice measurement enablement indicator are specified in the measurement request; and
perform the network slice performance measurement according to a network granularity specified in the measurement request when the network slice measurement enablement indicator is specified in the measurement request but no network slice identities are included in the measurement request.

13. The method of claim 12, wherein the network granularity comprises one or more network levels including at least one of a DRB level, a PDU session level, or a QoS flow level.

14. The method of claim 2, further comprising receiving a network slice measurement report from the user device.

15. The method of claim 14, further comprising forwarding the network slice measurement report received from the user device to a core network or a QCE of the communication network platform when one or more network slice identifiers are present in the network slice measurement report.

16. The method of claim 14, further comprising, when the network slice measurement report does not include any network slice identities:
forwarding the network slice measurement report received from the user device without network slice identities to a core network or a QCE of the communication network platform; or
identifying a set of network slice identifier associated with the network slice measurement report by one or more traffic identifiers included in the network slice measurement report followed by forwarding the network slice measurement report and the set of network slice identifiers to a core network or a QCE of the communication network platform, the traffic identifiers including at least one of:
one or more DRB identifiers;
one or more PDU session identifiers; or
one or more QOS flow identifiers.

17. The method of claim 14, wherein the network node forward the network slice measurement report to a core network or a QCE of the communication network platform to cause the core network or the QCE to perform optimization resource allocations for the one or more network slices according to the network slice measurement report and performance requirement specified in service-level agreements associated with the one or more network slices.

18. A method performed by a base station of a wireless communication network platform for measuring performance of network slices implemented in the wireless communication network platform, comprising:
identifying a user device within a coverage area of the base station to perform a network slice performance measurement;
determining a set of measurement configuration information associated with the network slice performance measurement;
constructing a measurement request comprising the set of measurement configuration information; and
transmitting the measurement request to the user device as a radio resource control (RRC) message to trigger the network slice performance measurement by the user device.

19. The network node comprising a processor and a memory, wherein the processor is configured to read computer code from the memory to implement a method in claim 1.

20. A computer program product comprising a non-transitory computer-readable program medium with computer code stored thereupon, the computer code, when executed by a processor, causing the processor to implement a method of claim 1.
